(19) United States
(12) Patent Application Publication
(10) Pub. No.: US 2019/0381887 A1
(43) Pub. Date: Dec. 19, 2019

(54) A Method for Operating an Operating System, Operating System and Vehicle With an Operating System

(71) Applicant: Volkswagen Aktiengesellschaft, Wolfsburg (DE)

(72) Inventor: Heino Wengelnik, Wolfsburg (DE)

(73) Assignee: Volkswagen Aktiengesellschaft, Wolfsburg (DE)

(21) Appl. No.: 16/481,207

(22) PCT Filed: Jan. 11, 2018
(86) PCT No.: PCT/EP2018/050696

§ 371 Date: Jul. 26, 2019

(30) Foreign Application Priority Data
Jan. 26, 2017 (DE) 10 2017 201 236.6

(51) Int. Cl. B60K 37/06; G06F 3/00; G06F 3/01

(52) U.S. Cl. CPC B60K 37/06; G06F 3/005; G06F 3/016; B60K 2370/21; B60K 2370/143; B60K 2370/146; B60K 2370/158; G06F 3/017

(57) ABSTRACT

The invention relates to a method for operating an operating system in which an operating action of a user is detected in a detection region of a detection unit, feedback data are generated using the detected operating action and transmitted to a feedback device, and a haptically-perceptible output signal is output in a transmission region by the feedback device using the feedback data. The transmission region and the detection region are arranged at a distance from each other. The invention furthermore relates to an operating system with a detection unit that has a detection region in which an operating action of a user is detectable, a control unit by means of which feedback data can be generated using the detected operating action, and a feedback device to which the feedback data can be transmitted. In this case, the feedback device has a transmission region in which a haptically-perceptible output signal can be output using the feedback data. The transmission region and the detection region are arranged at a distance from each other.

### CROSS-REFERENCE TO RELATED APPLICATIONS

This application claims priority to German Patent Application No. DE 10 2017 201 236.6, filed on Jan. 26, 2017 with the German Patent and Trademark Office. The contents of the aforesaid Patent Application are incorporated herein for all purposes.

### TECHNICAL FIELD

The present invention relates to a method for operating an operating system, an operating system, as well as a vehicle with an operating system.

### BACKGROUND

The familiarity of a variety of electronic apparatuses in the everyday life of many users has led to a significant need of ways to display information and render operation possible for the user. This is accomplished in particular with the assistance of displays that are now frequently used and often have large dimensions as a result of decreasing costs and advances in technical development. In combination with a touch-sensitive surface, so-called touchscreens are used in many areas for detecting user input.

For example, in order to be able to operate various electronic apparatuses, multifunctional operating systems are frequently used that comprise one or more multifunctional displays and operating elements with which the apparatuses can be operated. In this context, operation is supported, or respectively guided by the information reproduced on the multifunctional display. Furthermore, the information that is to be displayed on the multifunctional display can be selected by such an operating system.

However, the size of modern displays in particular is associated with specific challenges, for example when it is more difficult for the user to become oriented on the display area and find the relevant information quickly, or when the user's hand hovers freely over a relatively large surface while operating a large touchscreen.

Furthermore, in certain areas of using operating systems, there is the challenge that the user can only direct limited attention to its use. For example, the driver of a vehicle should be diverted as little as possible from observing the surrounding traffic and driving his own vehicle.

DE 10 2014 222 528 B4 proposes a restraining belt for a vehicle passenger that has a sensor layer by means of which entries can be detected. The belt furthermore has a substrate with a changeable feel that is perceptible by the user by means of recesses and/or elevations. This provides the user with feedback during operation without a visual contact being necessary.

With the motor vehicle proposed in DE 10 2013 001 323 B3 that has a communication apparatus, a safety belt with a vibrating apparatus is provided. A vibration process is triggered while establishing a communication link.

The method described in DE 10 2014 201 037 A1 for transmitting information to the driver of a vehicle provides controlling a haptic feedback unit. In this context, the haptic feedback unit is arranged on a surface of an input mechanism for controlling the vehicle, such as a steering wheel.

DE 10 2013 226 012 A1 describes a method for controlling a function in a vehicle. In this case, a touch of a surface by a finger is detected. The surface comprises a haptic feedback unit by means of which the surface can be changed in order to generate palpable barriers at the position of the finger and thereby simulate analog operating elements.

The fitness armband described in US 2014/0180595 A1 can for example interact with a user by means of vibrations as well as output haptic feedback. For example, the armband can communicate by means of a vibration that the user has achieved a certain objective. Furthermore, gestures can be detected by the armband as entries.

### SUMMARY

An object of the present invention is therefore to provide a method for operating an operating system, an operating system, as well as a vehicle with an operating system that enables particular easy and reliable operation for a user.

The object is solved according to the invention by a method, an operating system, and a vehicle according to the independent claims. Various embodiments are apparent from the following description and from the dependent claims.

### BRIEF DESCRIPTION OF THE DRAWINGS

IN THE FIGS.:

FIGS. 1 and 2 show an exemplary embodiment of an operating system in a vehicle.

### DETAILED DESCRIPTION

According to a first aspect, an operating action of a user is detected within a detection region of a detection unit. By using the detected operating action, feedback data are generated and transmitted to a feedback device. By means of the feedback device, a haptically-perceptible output signal is output using the feedback data in a transmission region, wherein the transmission region and detection region are arranged at a distance from each other.

Haptically-perceptible feedback for the detected operating action can thereby be output to the user. Operation therefore occurs with particularly great reliability since the user can perceive the respective feedback without having to direct his attention, for example, to another output unit.

The present aspect makes it possible to generate a haptically-perceptible output signal even when features of the detection unit render integration of such feedback in the detection unit difficult. For example, when using vibrations as haptic feedback, it is desirable to generate significant accelerations and high frequencies in order to be able to generate as “sharp” a signal as possible. This is for example associated with challenges when the touchscreens are larger and have a correspondingly high mass. The present aspect now allows the detection unit to be separated from the feedback device that outputs the haptically-perceptible output signal, enabling restricted output options by other elements of the operating system to be expanded.

In doing so, the operating action is detected in a known manner, wherein operating actions of various types may be provided. To accomplish this, the detection unit may comprise a sensor by means of which an action of the user, in particular by means of an actuating object, can be detected in the detection region. In particular, the detected action is subsequently evaluated, an operating intention is determined, and a control signal is generated.

The detection region may be composed in various ways in order to enable detection of various types of operating actions. In particular, the detection region may in some embodiments be designed two-dimensionally or three-dimensionally. With a two-dimensional detection region, operating actions are detected along a certain area, in particular a surface. With a three-dimensional detection region, operating actions may be detected within a spatial volume, wherein operating actions along an area may furthermore be comprised.

The detection region in some embodiments may be defined by the sensor of the detection unit, for example a two-dimensional detection region of a touch-sensitive surface of the detection unit, or a three-dimensional detection region of a camera sensor. Moreover, operating actions may comprise an actuation of a switch, such as a push-button switch or toggle switch, or a pilot switch, wherein the switch or pilot switch may, e.g., comprise a sensor for detecting the operating action.

In some embodiments, the operating action is detected by means of a touch-sensitive surface and/or a camera. This can render detection particularly easy, wherein means for detection are employed that are already frequently used.

For example, the operating action may be detected using resistive and/or capacitive areas. Detection by a camera sensor may occur in a touch-free manner using time-resolved video data from the detection region, wherein the detected user movements can be assigned to certain gestures by a connected analytical unit. Furthermore, touch-free detection may occur by an infrared strip, a light barrier, or an ultrasonic sensor in a known manner. Other forms and mixed ways of detection may also be used.

The operating action of the user may for example comprise a gesture. By detecting operating actions by means of gestures, the user is provided with a particularly easy and intuitive input option for various operating actions. A “gesture” within the context of the present discussion is understood to be a certain placement or a certain movement of an actuating object. The actuating object can in particular be a body part of the user, for example a finger or a hand. Alternatively or in addition, another actuating object may for example be provided, such as a suitable pen, for example with a special technical design that enables or facilitates the detection of a gesture by means of the actuating object. The gestures are performed within the detection region, i.e., along an area within a certain region in the case of a two-dimensional detection region, and within a spatial region in the case of a three-dimensional detection region. In particular, gestures are detected touch-free in a space or during an ongoing touching of the detection unit, in particular its surface.

In some embodiments, the detected operating action comprises an entrance of an operating object into a region of approach, a touch gesture, a swiping gesture or a pointing gesture. The gestures may thereby be configured in a known manner.

For example, pointing gestures, swiping gestures and/or comparable gestures are used with which users are familiar from daily use, as well as for example hand rotations, gripping gestures and combinations of a plurality of gestures that may be performed very quickly in sequence.

The region of approach may be configured as a specific spatial or surface region, for example as a region within a specific distance from a defined point or object. In particular when the actuating object enters the region of approach, a switch from a display mode to an operating mode of the operating system may be provided. The region of approach in this case is in particular defined such that it comprises a space in an environment of an operating element, i.e., the entry into the region of approach is detected in this case before engaging in operating the operating element. The operating mode can then be activated by adapting for example a display on a user interface, so that particularly easy operating is enabled.

The gesture may in some embodiments furthermore comprise a movement executed by means of the actuating object, in particular by a hand of the user. In this case, the gesture may be assigned to a direction that in particular is linked to a direction of movement or a function which is assigned to the gesture. For example, the gesture can be interpreted as a displacement of an operating object.

In some embodiments, the operating action comprises at least one segment of a gesture that is executed in a three-dimensional space, i.e., in particular without touching a surface. Alternatively or in addition, the operating action may comprise at least one segment of a gesture that is executed along a surface. The operating action may furthermore be executed entirely in two or three dimensions, or the various gesture segments may execute an operating action in the three-dimensional space and along a two-dimensional surface.

In some embodiments, a user interface is furthermore displayed by a display unit, and the operating action is detected with reference to the displayed user interface. Therefore, the present method can be used for operating a graphic user interface.

The user interface is generated and displayed in a known manner, for example by a display surface, in particular a touchscreen. A “user interface” within the context of the present discussion defines a display for a human/machine interface. In this context, technical apparatuses can be operated by means of control elements for which, e.g., buttons or icons on the display of the user interface can be used. In some embodiments, the user interface can comprise switching and operating elements that detectably show the operation of a functionality for a human. For example, the amount of a parameter can be shown, and its setting can be visualized by a setting element. The user interface can moreover comprise elements for displaying information and thus enable output that can be interpreted by a human.

Within the context of the present discussion, a switching element is understood to be an operating element of a graphic user interface. A switching element differs from elements and areas for just displaying information, so-called display elements, in that they can be marked and selected. When a switching element is marked, it can be shown highlighted, i.e., by being graphically highlighted relative to unmarked switching elements. Furthermore, a marked switching element can be selected by means of an operating action. When a switching element is selected, a function assigned to it is executed. The function can only cause a change in the information display. Furthermore, apparatuses can be controlled by the switching elements, the operation of which is supported by the information display. The switching elements can hereby replace conventional mechanical switches.

The operating action may be detected by means of a spatially-resolved touch detection apparatus with which the position of a user's touch is determined with an operating element on the display surface, and this position is assigned to a switching element of the graphic user interface, wherein the switching element is marked and/or selected.

In an operating action that is detected two-dimensionally, a pressure or a touch, for example on a touchscreen, may for example be detected at a specific position of a touch-sensitive surface. In case of a touch, a direct contact is established between the actuating object and the touch-sensitive surface. Furthermore, it may, however, be provided that, for example in case of capacitive sensors, the touch does not have to be completely executed; instead, an approach right up to the surface may already be considered a touch. For example, a glass plate may be arranged between the actuating object and the actual touching sensor so that the sensor itself is not touched; instead, a touching of the glass plate is sufficient.

In this case, the duration of the exerted pressure or of the touching may furthermore be detected, for example in order to differentiate between a single press and a longer duration of pressure above a certain threshold value (long press). Moreover, a slider may be shown as an operating element, wherein a swiping movement may be provided as the actuation, or respectively setting of the operating element. In a similar manner, an operating element can be moved from a starting position to a target position within the graphic user interface by dragging and dropping. Furthermore, it may be provided that a displacement of the shown user interface is displayed using a swiping gesture in a region of the graphic user interface, for example in order to display various sections of a user interface whose dimensions are larger than the displayable area. In this context, a distinction may furthermore be drawn between various types of touching the touch-sensitive surface, such as touching with one, two, or three fingers. Moreover, touches at several positions may be evaluated, for example at two positions at a distance from each other in order to perform operations such as rotating or scaling an object or a view (zoom, extending or compressing). Furthermore, other gestures may be detected and evaluated on a touch-sensitive surface.

With an operating action that is detected three-dimensionally, a movement path as well as a change of a placement over time or holding an actuating object, such as the hand of the user, can be detected. For example, a swiping gesture may be detected in a certain direction that for example comprises a movement of the actuating object from one side to another. In particular, a swiping movement in the horizontal or vertical direction may be detected.

In doing so, the direction of a movement may be detected in various ways, in particular by detecting a movement through various spatial regions, such as a left and a right region. This way, the resolution may be composed differently during detection, for example with two spatial regions, so that a change between these two regions may be interpreted as a movement in a certain direction. Furthermore, a plurality of spatial regions may be provided, in particular in a three-dimensional arrangement, so that movements in different spatial directions and/or with a higher spatial resolution may be determined.

Furthermore, a pointing gesture may be detected, wherein a direction as well as a position of the user interface is determined in particular using a placement, a position, and/or a progression of movement of the actuating object. For example, the position may be determined as a point of intersection of the plane of the display of the user interface with the specific direction. In doing so, the pointing gesture may be used for example to select and/or mark an operating object of the user interface, analogous for example to a touching gesture on a surface. Furthermore, by using further gestures, operations can be performed analogous to the operations described above for two-dimensional lists such as a rotation or scaling of an object or a view.

When detecting a gesture in a three-dimensional detection region, the posture of a hand can furthermore be taken into account, such as an open or closed posture, as well as the curvature of individual fingers of the hand.

According to the present aspect, feedback data are generated using the operating action and transmitted to the feedback device in a known manner. To accomplish this, there is at least temporarily a data link between the detection unit and the feedback device. In particular, a link may exist by means of electromagnetic waves, such as by Bluetooth, infrared or WLAN.

The data link may furthermore be composed such that the transmission of the feedback data is carried out in combination with an identification of the feedback device, for example by transmitting the feedback data to a specific feedback device, or the transmission is only carried out to a feedback device of a specific user. In this manner, it can be ensured that the haptically-perceptible feedback is only output for a specific user. This moreover makes it possible to perform settings using personal preferences.

In some embodiments, the haptically-perceptible output signal comprises a vibration with a frequency, an amplitude, and a duration. Beneficially, a very easily perceptible output signal can thereby be generated that furthermore gives the user familiar feedback for an operating action.

The output signal may furthermore comprise a plurality of vibrations, such as a plurality of vibrations of a specific duration within a specific time period. The amplitude and the frequency may furthermore be composed variably over time, i.e., they may change over the duration of the output vibration, for example in order to output initially less and then increasingly more intense vibrations.

The feedback device may be formed in a known manner. It may comprise in particular an actuator that is effectively linked to the transmission region. This may for example be a motor by which a movement can be generated by which a pulse can be transmitted to a specific area of the feedback device.

The transmission region may be formed in different ways, for example by a contact surface, by means of which a contact is formed, in particular a frictional connection between the feedback device and the skin of a user. The contact does not have to exist directly; instead, it can occur indirectly, for example through clothing. Depending on the type of the haptically-perceptible feedback, this may be influenced differently by the type of contact with the user, for example by a damping effect of clothing in the transmission of pulses.

In some embodiments, the feedback device is at a distance from the detection unit and is arranged on the body of the user. Haptically-perceptible feedback may thereby be output even though a spatial separation exists between the detection unit and the feedback device.

In some embodiments, the feedback device is fastened to an arm, for example in the region of a wrist of the user. The feedback device accordingly moves together with a hand of the user that can be used to execute operating actions or to guide an actuating object. This enables a particularly close coupling of the haptically-perceptible feedback signal to the user. The output may occur in particular in a very easy and intuitively perceptible manner, for example by outputting the feedback close to the hand by means of which the operating action was carried out. That is, a close local relationship can be established between the location of the operating action and the location of the haptically-perceptible output signal, wherein the spaced arrangement of the transmission region and the detection region is nonetheless retained.

Devices for generating feedback by means of vibration are known, for example from the field of cell phones, fitness armbands, smart watches, or comparable apparatuses. Of course, other embodiments of the feedback device are conceivable, such as an arm ring, finger ring, necklace or chain, glasses, earrings or other jewelry items, implants or gloves. Furthermore, the feedback device may also comprise a safety belt, a steering wheel or a seat, or respectively be integrated therein.

With known systems, the user is typically notified of a message by the mechanism, for example an incoming call on a cell phone. In contrast, the haptically-perceptible feedback, in particular a vibration according to the present aspect is output as feedback by the feedback device by an input using another apparatus, wherein this other apparatus represents an independent unit separate from the feedback device. For example, feedback is output by an operation of a touchscreen in a vehicle by means of a smart watch, or haptically-perceptible feedback is generated and output using a three-dimensional gesture.

This expands the options for outputting haptically-perceptible feedback. In this regard, it is in fact required in known systems for user contact to exist with the operated apparatus that also outputs the haptically-perceptible feedback. For example, a vibration of an operated touchscreen can be output while the user touches it. However, the present aspect also enables outputting the feedback in a haptically-perceptible manner even though the direct, in particular frictional contact of the user with the apparatus is interrupted in a certain situation, for example when lifting the finger off the touchscreen.

The present aspect moreover enables outputting haptically-perceptible feedback even though the operated apparatus such as the touchscreen is not configured for this. The physical separation of the detection unit from the feedback device also enables the haptically-perceptible feedback to be configured in a user-specific manner and/or specifically for the respective feedback device. For example, configurability of the operating system may be provided, wherein different users may set different types or configurations of the haptically-perceptible feedback.

According to the present aspect, the transmission region and the detection region are arranged spaced, i.e., at a distance from each other. This means in particular that when the operating action is detected using a touch-sensitive surface, the transmission region is arranged at a distance from the surface for detecting the operating action. For example, the operating action is performed by means of a finger on a surface of a touchscreen, wherein the transmission region is a contact surface between a smart watch and a skin surface of the user.

I.e., for example, with an operating action on a two-dimensional detection region, the contact surface between the finger of the user and the touch-sensitive surface is different to the contact surface between the feedback device and the user. Furthermore, when detecting a three-dimensional gesture, the detection region in which for example a gesture of a hand is detected is different from the transmission region, i.e., for example a contact region between the feedback device and the user.

In this context it is moreover provided in some embodiments that the transmission region and the detection region are considered to be spaced from each other when they are designed fundamentally different, in particular when the detection region is designed three-dimensionally and the transmission region is designed two-dimensionally. That is, a two-dimensional transmission region is considered “at a distance” from a three-dimensional detection region even when the two-dimensional transmission region is located within the detection region.

For example, gestures can be detected in a three-dimensional space in the method according to the present aspect. If the haptically-perceptible feedback is output by means of a smart watch on the wrist of the user, this wrist with the watch can in fact be located within the detection region, however, the gesture is detected and evaluated using the three-dimensional movement of the hand, whereas the contact surface between the watch and the wrist is irrelevant to the detection of the gesture. In particular, the transmission region in this case is covered and cannot be detected by the detection unit, such as a camera, for detecting a three-dimensional operating action.

In some embodiments, the feedback data comprise a first or second feedback type, and the output signal is formed depending on the feedback type. Therefore, various types of feedback can be output.

For example, various classes of feedback can be distinguished such as positive and negative feedback. If for example an operating action is performed that comprises a swiping gesture, a displacement of an operating object can be accomplished using this gesture. With regard to this displacement, it can be distinguished whether it could be performed according to the operating action or whether the displacement was unsuccessful, for example because a movement beyond a specific displacement limit (stop) is not provided. The haptically-perceptible output signal mY be generated differently depending on the classification of the accomplished operating action.

In other examples, other different classifications of the feedback data may be provided as the various feedback types alternatively or in addition. The output signals that are generated depending on the respective feedback type may differ in various ways from each other, for example by a vibration with different intensity, duration and/or frequency, or by a specifically composed sequence of a plurality of vibrations.

In another design, the feedback data are transmitted by an exchange unit to the feedback device. This may facilitate the incorporation of various feedback devices of an operating system.

For example, it may be provided that the feedback data are transmitted by a possibly detachable cabled data link to the exchange unit. It may furthermore be provided that the feedback data are transmitted via another in particular wireless data link to the feedback device. In this context, processing of the feedback data by the exchange unit may be carried out, for example in order to enable the output of the output signal by the feedback device. In this context, for example a configuration of the haptically-perceptible feedback may be configured by means of the exchange unit that defines the output signal using the feedback data and causes a correspondingly composed output signal by the transmission of processed data to the feedback device.

For example, the detection unit for the operating action may be part of a vehicle with which a cell phone furthermore has a separable data link. Moreover, there may be a data link from the cell phone to a smart watch, for example by means of a radio connection. Feedback data may then first be transmitted to the cell phone which then transmits the feedback data to the smart watch. In this context, further processing of the feedback data may be carried out by the cell phone before the processed data are transmitted to the smart watch in order to generate the output signal there. In doing so, further processing may for example occur using a configuration in which a user can set a specific intensity of the output signal.

In some embodiments, a visually and/or acoustically perceptible additional output signal may furthermore be generated and output. This may amplify the effect of the feedback. The additional output signal is output in this case in addition to the haptically-perceptible output signal. For example, the feedback device, a display unit, or another output apparatus can be used for outputting.

The operating system according to the another aspect comprises a detection unit that has a detection region in which an operating action of a user is detectable. It furthermore comprises a control unit by means of which feedback data can be generated using the detected operating action, as well as a feedback device to which the feedback data can be transmitted. In this case, the feedback device has a transmission region in which a haptically-perceptible output signal can be output using the feedback data. The transmission region and the detection region are arranged at a distance from each other.

The operating system may be designed in some embodiments to implement the method according to the preceding aspect described above. The operating system thus has the same advantages as the method according to the preceding aspect.

In some embodiments of the operating system, the detection unit comprises a touch-sensitive surface, or an apparatus for detecting electromagnetic waves. Beneficially, operating actions may thus be detected using a touch of an area, or using a gesture in a three-dimensional space.

A vehicle according to another aspect comprises an operating system according to the above description.

In some embodiments, the vehicle comprises the detection unit, and a mobile user mechanism comprises the feedback device. The haptically-perceptible output signal is thus output by an apparatus which is formed separately by a vehicle-internal detection unit.

In some embodiments, it is provided that the detection unit is a vehicle-internal apparatus, whereas the feedback device is a vehicle-external unit that however is arranged within the vehicle. The feedback device may in this context be fastened to the body of the user, wherein the haptically-perceptible output signal is transmitted by means of a transmission device to the user, for example by means of an area in direct or indirect contact with the skin surface of the user. For example, an infotainment system of the vehicle comprises the detection unit, for example designed as a touchscreen in the vehicle, and the feedback device is a smart watch of the user.

The invention will now be explained using further exemplary embodiments with reference to the drawings.

A vehicle 1 comprises a control unit 6 to which a touchscreen 5 and a detection unit 3, in the shown example a camera 3, are coupled. Furthermore, a communication unit 9 is coupled to the control unit 6. The touchscreen 5 comprises another detection unit 2 that is designed as a touch-sensitive surface 2 in the exemplary embodiment, and a display unit 4. In the exemplary embodiment, an approach detection unit 15 is arranged on the bottom edge of the touchscreen 5 and is also coupled to the control unit 6. In this context, the different components of the vehicle 1 can be for example coupled by a CAN bus of the vehicle 1.

Furthermore, an exchange unit 8, in the shown case a cell phone 8, a feedback device 7, in the shown case a smart watch 7, as well as an actuating object 10 are arranged in the vehicle 1. The actuating object 10 is a finger 10 of a user in the exemplary embodiment. In other exemplary embodiments, the actuating object is a hand/or another body part of the user, a pen or another suitable object and/or a device.

The touchscreen 5 is designed in a known manner. The touch-sensitive surface 4 is arranged on a display area of the display unit 4, i.e., between the display unit 4 and an observer. For example, a film may be arranged over the display unit 4 by means of which the position of a touch by an actuating object 10 can be detected. The actuating object 10 is in particular the tip of a finger 10 of a user. The film may for example be designed as a resistive touch film, capacitive touch film or piezoelectric film. Furthermore, the film may be designed such that a flow of heat that for example proceeds from the tip of the finger 10 is measured.

Various inputs can be obtained from the progression over time of the touching of the film. For example, in the simplest case, the touching of the film can be detected at a specific position and assigned to a graphic object displayed on the display area 2. Moreover, the duration of the touch may be detected at a specific position, or within a specific region. Furthermore, gestures may be detected, wherein in particular a change over time of the position of the touch of the touch-sensitive surface 2 can be detected and evaluated, wherein a gesture is assigned to a path of movement.

Temporally and spatially resolved image data are detectable in a known manner by a camera sensor of the camera 3. In this case, the camera 3 has a detection range that in particular is defined by the design of the camera sensor as well as an optical system of the camera 3. The image data are detectable within the detection range such that they are suitable for evaluating and recognizing gestures. The detection range of the camera 3 is for example designed such that movements, placements and positions of an actuating object 10 such as a hand are detectable within a specific spatial region in the interior of the vehicle 1. The detection range of the camera 3 may furthermore comprise the display area of the touchscreen 5 so that for example a position of a fingertip relative to the touchscreen 5 can be determined using the detected image data.

The approach detection unit 15 is formed in the exemplary embodiment such that an approach by the actuating object 10 to the touchscreen 5 is detectable. In this case, the approach detection unit 15 has a detection region which extends over a spatial region between the touchscreen 5 and a typical observer position. In particular, the detection region of the approach detection unit 15 is arranged close to the touchscreen 5. In this regard, the approach is detected when the actuating object 10 enters the detection region.

The approach detection unit 15 may be designed as a sensor strip and may, for example, comprise a reflective light barrier that comprises at least one lamp for emitting electromagnetic detection radiation into the detection region and a receiving element for detecting a portion of the detection radiation scattered and/or reflected by the actuating object 10. It may in particular be designed such that the actuating object 10 may be recognized in the detection region using the intensity of the received detection radiation.

The detection region may furthermore have a plurality of detection zones, such as two detection zones at the right and the left, top and bottom, or in another arrangement. The approach detection unit may furthermore comprise various lamps for the individual detection zones that each emit electromagnetic detection radiation into the respective detection zone.

Moreover, a modulation device for modulating the emitted detection radiation may be provided so that the detection radiation that is emitted into the individual detection zones always differs with regard to its modulation. In this case, the approach detection unit may also comprise an analytical unit which is designed so that the received, reflected and/or scattered detection radiation can be analyzed with regard to its modulation in order to ascertain the detection zone in which the detection radiation was scattered or reflected by an actuating object.

The exemplary embodiment provides that a graphic user interface is displayed by the display unit 4 of the touchscreen 5 which can be operated using the touch-sensitive surface 2. In this case, a distinction is made between a display and an operating mode of the graphic user interface, wherein the operating mode is activated when an approach by the actuating object 10 to the touchscreen 5 is detected by the approach detection unit 15, whereas the display mode is activated when no such approach is detected. In display mode, the display is composed such that the information is shown very clearly and easily detectable. In operating mode, the display is composed such that operating elements are in particular highlighted, for example by being shown larger in order to facilitate entries by a user.

The smart watch 7 is arranged on the wrist of the hand of the finger 10 such that direct contact is established between the skin of the user and an area of the smart watch 7. In other exemplary embodiments, the feedback device 7 is designed differently such as an arm ring, finger ring, necklace or chain, glasses, earrings or other jewelry item, implant or glove. Furthermore, the feedback device can also comprise a safety belt, a steering wheel or a seat, or respectively be integrated therein. In each case, the feedback device 7 is suitable for generating a haptically-perceptible output signal and transmitting it to the body of the user. In doing so, direct contact may exist in a transmission region between the feedback device 7 and the body; the contact may furthermore be established indirectly, for example through clothing.

The haptically-perceptible output signal is output in a known manner, for example by means of a motor with an imbalance, wherein a vibration of the inert mass of the feedback device 7 is initiated by a movement of the motor, in particular via an area in the transmission region. Alternatively or in addition, the haptically-perceptible output signal may be output in another way.

In the exemplary embodiment, the communication unit 9, the cell phone 8 and the smart watch 7 are coupled to each other by wireless data links. The data link occurs in each case in a known manner, for example by a local network or a larger network, such as a local network in the vehicle 1. The link can for example be established by means of WLAN or Bluetooth.

In other exemplary embodiments, the data link of the cell phone 8 can be established with the communication unit 9 for example by the connection of a data cable. In other exemplary embodiments, a direct data link can exist between the feedback device 7 and the communication unit 9.

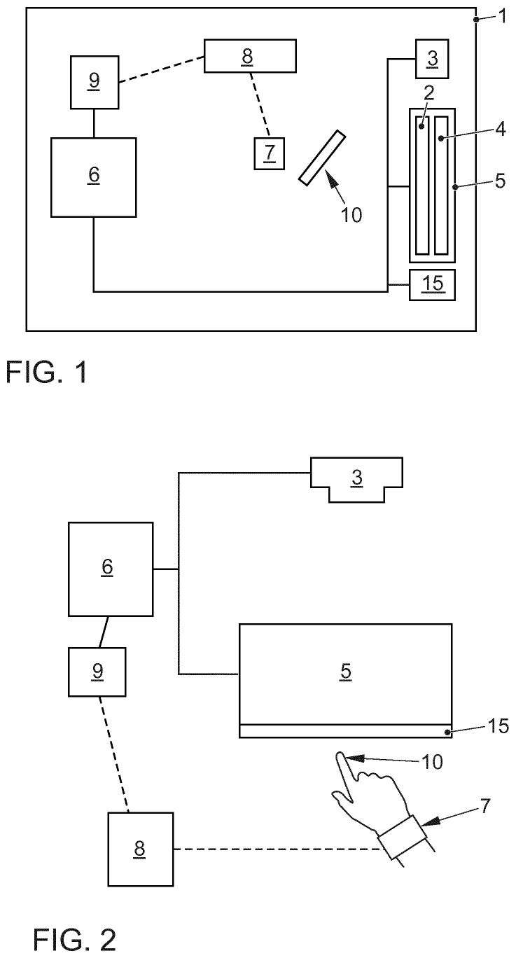

An exemplary embodiment of the operating system according to the method will be explained with reference to FIGS. 1 and 2. In this case, the above-explained exemplary embodiment of the operating system will be referenced.

An operating action of the user is detected in a first step. This is executed by means of the actuating object 10 and can be detected in the exemplary embodiment by various apparatuses of the vehicle 1 which each have a specific detection area. By means of the touch-sensitive surface 2 of the touchscreen 5, operating actions can be detected that are performed by the finger 10 in contact with the touch-sensitive surface 2. The touchscreen 5 is furthermore designed to detect the actuating object 10 at a specific position at a slight distance from the touch-sensitive surface 2, for example a distance of up to 3 cm to a position on the touch-sensitive surface 2. In this manner, hovering the actuating object above the touch-sensitive surface 2 can be detected. Furthermore, the approach detection unit 15 detects whether the finger 10 is located in a detection region close to the touchscreen 5. Moreover, image data are detected and analyzed by the camera 3 in its detection region, wherein the temporally changing position, posture and placement of the hand of the user with the finger 10 is detected and evaluated, and a gesture is recognized if applicable.

In other exemplary embodiments, the operating action may be detected in another way or by using only one of the described options.

The feedback data are generated by the control unit 6 using the detected operating action and transmitted by means of the communication unit 9 via a data link to the exchange unit 8, the cell phone 8 in the exemplary embodiment. By the data link of the cell phone 8 to the feedback device 7, the smart watch 7 in the exemplary embodiment, the feedback data are transmitted thereto. By means of the smart watch 7, a haptically-perceptible output signal is output—a vibration, a specific intensity, frequency and duration in the exemplary embodiment—using the feedback data. Furthermore, a plurality of sequential vibration signals can be output.

The properties of the output signal may be composed differently using the feedback data, for example by distinguishing between positive and negative feedback. In this case, two different haptically-perceptible output signals may for example be generated and output, such as with a different intensity, frequency and duration. Furthermore, different sequences of vibration signals can be output.

In other exemplary embodiments, it may be provided that preliminary processing of the feedback data may be performed by the cell phone 8, wherein for example different types of feedback for different operating actions and/or types of feedback data are determined.

In the exemplary embodiment, it is provided that haptic feedback is output when an approach of the actuating object 10 to the touchscreen 5 is detected. The detection is carried out using the approach detection unit 15 which generates a detection signal when the finger 10 of the user is detected in the detection region in front of the touchscreen 5. A vibration of a given intensity, frequency and duration is output when the entry of the finger 10 is detected in the detection region, as well as when a departure of the finger 10 is detected. The output signal can differ depending on whether an entrance or exit is detected.

Furthermore, swiping gestures can be recognized that are executed by the finger 10, the hand of the user, or another actuating object 10 in the detection region of the approach detection unit 15. In the exemplary embodiment, the approach detection unit 15 has a divided detection region, wherein approaches in the left or right region in front of the touchscreen 5 are detectable separately from each other. In other exemplary embodiments, the regions may be arranged in a different way, for example stacked vertically, or more than two regions may be provided.

A swiping gesture executed in the three-dimensional space is recognized when the actuating object 10 is first detected in the one region and then in the other, i.e., when the actuating object 10 executes a movement between the regions of the detection region. For example, the actuating object 10 is first detected on the right and then on the left in the detection region, and a swiping gesture to the left is recognized. Using this swiping gesture, the control unit 6 generates a control signal, for example to correspondingly shift a section of a user interface displayed by the display unit 4. Furthermore, feedback data are generated and transmitted via the cell phone 8 to the smart watch 7. An output signal is generated in a haptically perceptible manner by the smart watch 7, in case of the exemplary embodiment, a vibration at a specific intensity, frequency and duration.

In the exemplary embodiment, it is furthermore provided that haptically-perceptible output signals are output by the intelligent smart watch 7 when an operating action is detected on the touch-sensitive surface 2 of the touchscreen 5. The output signals can be output during the touching between the finger 10 and the touch-sensitive surface 2 as well as after the touching, i.e., after the contact between the finger 10 and the touch-sensitive surface 2 is released. Alternatively or in addition, haptically-perceptible output may be generated during an approach to the touch-sensitive surface 2, or at a specific position in the surroundings of the touch-sensitive surface 2.

In the example, a plurality of various operating actions are detected by the touch-sensitive surface 2. In this case, it may be provided that various types of haptically-perceptible output signals are generated for different operating actions, for example vibrations with a different intensity, frequency and duration, as well as differently composed sequences of vibration pulses.

A pressure may be detected at a position of the touchscreen 5, wherein furthermore the intensity of the exerted pressure may be considered. Furthermore, the duration of the pressure may be considered, and a long-lasting pressure (long press) may be recognized when the duration of a specific threshold value is exceeded, and the pressure may be interpreted differently depending on the duration. Furthermore, a swiping gesture on the touch-sensitive surface 2 may be detected, wherein the position of the touch of the finger 10 on the touch-sensitive surface 2 changes depending on the time, and in particular has a starting and end point. Depending on such a swiping gesture, a setting of a shiftable control element (slider) or a differently composed shift of an element may be carried out. Furthermore, elements of a graphic user interface output on the touchscreen 5 may be shifted, for example operable graphic elements, or a shown section of a user interface whose dimensions exceeds the size of the display unit 4. Furthermore, a distinction can be made as to whether a touch is detected by means of a finger 10 or several fingers. In other exemplary embodiments, other operating actions may alternatively or in addition be detected and interpreted by the touch-sensitive surface 2 of the touchscreen 5. In this case, different haptically-perceptible output signals may be provided by different operating actions.

An additional exemplary embodiment furthermore provides that, analogous to determining a touch of the touch-sensitive surface 2 by the finger 10, a position on the touchscreen 5 is determined when the finger 10 is located in close proximity to the touchscreen 5 without, however, executing a touch. In particular, the finger 10 hovers over a position of the touchscreen 5. This hovering may be detected in different ways, in particular by capacitive sensors of the touchscreen 5. In one exemplary embodiment when the finger 10 hovers longer than a certain threshold value over a certain position, a window with help information is opened at this position within the display, for example for a switching element shown at this position. It is furthermore provided in this case that a haptically-perceptible feedback is output in order to inform the user about the opening of the window.

In the exemplary embodiment, a distinction is furthermore drawn between various gestures that may be detected by the camera 3. In particular in doing so, a position, posture and placement of the actuating object 10, such as a hand of the user, is evaluated. Furthermore, a movement is taken into account, in particular a direction of movement. In a known manner, a distinction is drawn between various gestures executed in three-dimensional space, such as a swiping gesture to the right or left, or respectively upward or downward. Furthermore, a pointing gesture may be detected by means of which in particular a position is determined on the display unit 4 of the touchscreen 5. Furthermore, a gesture may be recognized for scaling an object that is output by the display unit 4, in particular within a spatial direction (stretch) or evenly in two directions (zoom out, zoom in). In other exemplary embodiments, other gestures may be detected by the camera 3 alternatively or in addition and interpreted as operating actions.

In the exemplary embodiment, a distinction is furthermore made as to whether to generate positive or negative feedback. For example, an operating action may be evaluated such that a successful or an unsuccessful instruction is output. For example, an operating action may accordingly comprise an instruction for a shift, and a “stop” may be provided for the shift, i.e., a spatial limit beyond which further shifting is impossible. Reaching the stop may be output by means of a negative output signal, whereas a positive output signal may be output in the event of a shift within the given limits.

Furthermore, the exemplary embodiment provides that the haptically-perceptible output signals are configurable. This occurs in a known manner, for example by means of a user input.

Furthermore, the actuating object 10, the hand or the finger 10 or respectively the user and/or the feedback device 7 can be identified, and the haptically-perceptible output signal can be composed depending on the identity. For example, various configurations of the haptic feedback can be provided for various users, actuating objects 10 and/or feedback devices 7, for example in order to adapt the haptically-perceptible output signal to the output options of the respective feedback device 7, or to the preferences of the user.

### REFERENCE NUMBER LIST

1 Vehicle

2 Touch-sensitive surface

3 Camera

4 Display unit

5 Touchscreen

6 Control unit

7 Feedback device; smart watch

8 Exchange unit; cell phone

9 Communication unit

10 Actuating object; finger

15 Approach sensor

The invention has been described in the preceding using various exemplary embodiments. Other variations to the disclosed embodiments can be understood and effected by those skilled in the art in practicing the claimed invention, from a study of the drawings, the disclosure, and the appended claims. In the claims, the words “comprising” and “including” does not exclude other elements or steps, and the indefinite article “a” or “an” does not exclude a plurality. A single processor, module or other unit or device may fulfil the functions of several items recited in the claims.

The mere fact that certain measures are recited in mutually different dependent claims or embodiments does not indicate that a combination of these measured cannot be used to advantage. Any reference signs in the claims should not be construed as limiting the scope.

What is claimed is:

1. A method for operating an operating system, wherein:
an operating action of a user is detected in a detection region of a detection unit;
feedback data are generated using the detected operating action and transmitted to a feedback device; and
using the feedback data, a haptically-perceptible output signal is output in a transmission region by the feedback device; wherein
the transmission region and the detection region are arranged spaced from each other.

2. The method according to claim 1, wherein the operating action is detected by means at least one of a touch-sensitive surface and a camera.

3. The method according to claim 1, wherein the detected operating action comprises an entrance of an operating object in a region of approach, a touch gesture, a swiping gesture, or a pointing gesture.

4. The method according to claim 1, wherein the operating action comprises at least one segment of a gesture that is executed in a three-dimensional space.

5. The method according to claim 1, wherein furthermore, a user interface is displayed by a display unit, and the operating action is detected with reference to the displayed user interface.

6. The method according to claim 1, wherein the haptically-perceptible output signal comprises a vibration with a frequency, an amplitude, and a duration.

7. The method according to claim 1, wherein the feedback device is arranged spaced from the detection unit and is arranged on the body of the user.

8. The method according to claim 7, wherein the feedback device is fastened to an arm, in particular in the region of a wrist of the user.

9. The method according to claim 1, wherein the feedback data comprise a first or a second feedback type; and the output signal is composed depending on the feedback type.

10. The method according to claim 1, wherein the feedback data are transmitted by an exchange unit to the feedback device.

11. The method according to claim 1, wherein furthermore, one or more of an optical and acoustically perceptible additional output signal is generated and output.

12. An operating system having:
a detection unit that has a detection region in which an operating action by a user is detectable;
a control unit using which feedback data can be generated using the detected operating action; and
a feedback device to which the feedback data are transmissible; wherein
the feedback device has a transmission region in which a haptically-perceptible output signal can be output using the feedback data; wherein
the transmission region and the detection region are arranged spaced from each other.

13. The operating system according to claim 12, wherein the detection unit comprises a touch-sensitive surface or an apparatus for detecting electromagnetic waves.

14. A vehicle with an operating system according to claim 12.

15. The vehicle according to claim 14, wherein the vehicle comprises the detection unit, and a mobile user mechanism comprises the feedback device.
